(19) United States
(12) Patent Application Publication
(10) Pub. No.: US 2014/0104247 A1
(43) Pub. Date: Apr. 17, 2014

(54) DEVICES AND SYSTEMS FOR RENDERING AMBIENT LIGHT EFFECTS IN VIDEO

(71) Applicants: Adam Li, Solana Beach, CA (US); Megan Farrell, San Diego, CA (US); Aixin Liu, San Diego, CA (US); Djung Nguyen, San Diego, CA (US)

(72) Inventors: Adam Li, Solana Beach, CA (US); Megan Farrell, San Diego, CA (US); Aixin Liu, San Diego, CA (US); Djung Nguyen, San Diego, CA (US)

(21) Appl. No.: 13/654,279

(22) Filed: Oct. 17, 2012

(51) Int. Cl. G09G 5/00

(52) U.S. Cl. 345/204

(57) ABSTRACT

Systems and devices for rendering video associated with ambient light effects are provided. A system includes a receiving device including at least one decoder programmed to parse an incoming video file to separate at least one track including at least one ambient light effect associated with at least one portion of the video file. The system further includes a processing module programmed to generate a command to at least one lighting device in communication with the receiving device to generate the ambient light effect included in track separated from the video file. The processing module is programmed to send the command to the lighting device for generating the ambient light effect included in the track separated from the video file when the portion of the video file associated with the ambient light effect is displayed to a user.

### FIELD

This invention relates to ambient light effects, and more specifically, to devices and systems for rendering ambient light effects in video.

### BACKGROUND

Television programs, movies, and video games most commonly provide visual stimulation from a television screen display and audio stimulation from the speakers connected to the television. There are some known systems that attempt to enhance a viewer's/user's experience by providing a more interactive/responsive environment. For example, some video gaming systems cause lighting devices such as lamps to generate an ambient light effect (“ALE”) during game play.

To provide an enjoyable interactive experience, the lighting devices need to generate the ambient light effects at appropriate times when the associated scene is displayed to a user. In addition, the lighting devices need to generate a variety of ambient light effects to appropriately match a variety of scenes and action sequences in a movie or a video game. Thus, an ambient light effect-capable system needs to be able to identify one or more scenes during the display of which an ambient light effect is to be generated.

One such system focuses on detecting and analyzing various parameters of the video file or video game application and generating ambient light effects based on the detected parameters. One problem with such an approach is that many video files and video games include various access restrictions imposed by the content providers, and such restrictions may make it difficult or impossible to analyze the parameters of a video file and/or video game.

Some existing systems include lighting devices that produce only various intensities and flickering of white colored light. A disadvantage of such systems is that while the television programs, movies, and video games typically include a wide variety of scenes, events, and action sequences, the known ambient light systems are limited to generating a single light color which may appear too repetitive to users and cause the users to lose interest in such ambient light effects. Accordingly, what is needed is a way of producing ambient light effects in association with one or more portions of a video file that overcomes the aforementioned shortcomings.

### SUMMARY

The present invention satisfies this need. In one embodiment, a system for rendering ambient light effects is provided. The system includes a receiving device including at least one decoder programmed to parse an incoming video file to separate at least one track including at least one ambient light effect associated with at least one portion of the video file. The system further includes a processing module programmed to generate a command to at least one lighting device in communication with the receiving device to generate the at least one ambient light effect included in the at least one track separated from the video file. The processing module is programmed to send the command to the at least one lighting device for generating the at least one ambient light effect included in the at least one track when the at least one portion of the video file associated with the at least one ambient light effect is displayed to a user.

The receiving device can be selected from one of a television, set-top box, disc player, personal computer, laptop, tablet computer, and mobile phone.

In one approach, the at least one track identifies the at least one lighting device for generating the at least one ambient light effect included in the at least one track. In another approach, the at least one track identifies at least one predetermined event in a video contained in the video file, the predetermined event being associated with the at least one ambient light effect.

In one approach, the receiving device and the at least one lighting device can be adapted to communicate directly via a wired connection. In another approach, the receiving device and the at least one lighting device are adapted to communicate directly via a wireless connection. In yet another approach, the receiving device and the at least one lighting device are adapted to communicate indirectly via an intermediate device adapted to communicate with both the receiving device and the at last one lighting device. In one approach, the intermediate device is a wireless controller.

In one approach, the receiving device and the at least one lighting device are adapted to communicate indirectly via a home automation controller integrated into the receiving device. The at least one home automation controller can be in communication with at least one electrical device not in communication with the receiving device.

The receiving device and the at least one lighting device can be adapted to communicate indirectly via a home automation controller located separately from the receiving device. The at least one home automation controller can be in communication with at least one electrical device not in communication with the receiving device.

In one approach, the at least one track includes chrominance control data specifying at least one color of the ambient light effect to be generated by the at least one lighting device, the color being selected from red, green, blue, or combinations thereof. In another approach, the at least one lighting device is adapted to interpret the command received from the receiving device to generate the at least one color specified in the chrominance control data in the at least one track.

In one approach, the at least one track can include data specifying brightness level of the at least one ambient light effect to be generated by the at least one lighting device. In another approach, the at least one track includes data specifying a predetermined time for generating the at least one ambient light effect by the at least one lighting device after receiving the command.

The systems and methods described herein provide an engaging experience to a user when watching television programming, movies, or playing video games. One advantage of the systems and methods described therein is that television programming, movies, and video games can be made more interactive for a user by including ambient light effects can be generated by one or more lighting devices. Another advantage is that the ambient light effects are generated directly by the video rendering devices based on information detected from the video file representing the television program, movie, or video game. Yet another advantage of the systems and methods described herein is that unlike prior systems producing ambient light effects in various shades of white, the ambient light effects described herein can include a large variety of colors. These and other advantages will be apparent upon consideration of the present specification.

### BRIEF DESCRIPTION OF THE DRAWINGS

FIG. 1 is a schematic diagram of several exemplary devices of a system according to one embodiment;

FIG. 2 is a schematic diagram of a method according to one embodiment; and

FIG. 3 is a schematic diagram of a method according to another embodiment.

### DETAILED DESCRIPTION

Reference will now be made in detail to the present preferred embodiments of the invention, examples of which are illustrated in the accompanying drawings.

Generally, systems and methods are described herein for providing ambient light effects for a user when watching television programming, movies, or playing video games. The ambient light effects can be generated by one or more lighting devices based on information, for example, additional tracks that are contained in the video files representing television programs, movies, and video games. The ambient light effects so generated can include chrominance control data resulting in ambient light effects to be presented to users in a variety of colors. As such, a dynamic and more interactive experience is provided for a user.

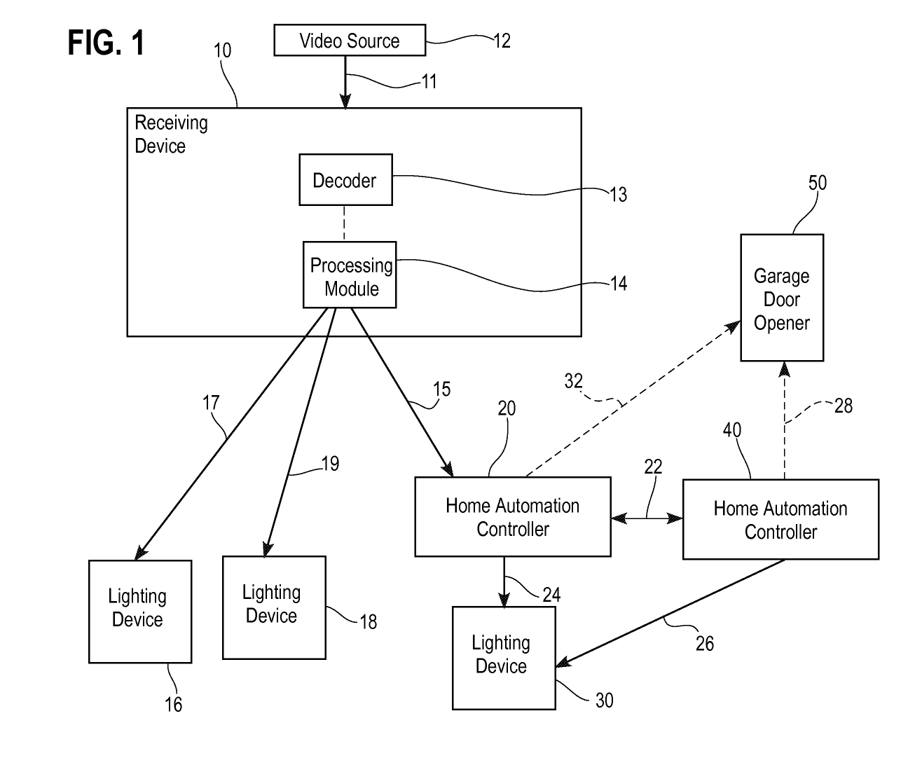

One embodiment of a system according to the present invention is shown in FIG. 1, where a receiving device 10 that receives incoming video content including one or more video files from a video source 12 is connected to two lighting devices 16 and 18 to a home automation controller 20. It is to be appreciated that the receiving device 10 illustrated in FIG. 1 has been shown by way of example only as being connected to both lighting devices 16 and 18 and a home automation controller 20. The receiving device 10 can also be connected directly only to one or more lighting devices or only to one or more home automation controllers 20.

FIG. 1 shows that the receiving device 10 is directly connected to two lighting devices 16 and 18 via connections 17 and 19, respectively. The receiving device 10 and the lighting devices 16 and 18 can be interconnected directly via wired or wireless connections, and the receiving device 10 and the lighting devices 16 and 18 can be interconnected as described in more detail in co-pending application entitled “VIDEO FILES INCLUDING AMBIENT LIGHT EFFECTS,” filed on Oct. 17, 2012, the entire disclosure of which is incorporated by reference herein.

In one approach shown in FIG. 1, the home automation system controller 20 is a physical device located separate from the receiving device 10 and connected to the receiving device 10 via a connection 15. The home automation controller 20 is in turn connected to the lighting devices 16 and 18 via connections 17 and 19, respectively. The connections 15, 17 and 19 can be wired or wireless connections.

As shown in FIG. 1, the home automation controller 20 is a physical device located separate from the receiving device 10 and connected to the receiving device 10 via a connection 15 (which can be wired or wireless). The home automation controller 20 can also be integrated into the physical structure of the receiving device as described in more detail in co-pending application entitled “AMBIENT LIGHT EFFECTS BASED ON VIDEO VIA HOME AUTOMATION,” filed on Oct. 17, 2012, the entire disclosure of which is incorporated by reference herein.

In an exemplary approach shown in FIG. 1, the home automation controller 20 is not connected to the lighting devices 16 and 18 which are directly connected to the receiving device via connection lines 17 and 19. Instead, the home automation controller 20 is connected to a lighting device 30 which is in communication with the receiving device 10 indirectly, via the home automation controller 20.

As shown in FIG. 1, the home automation controller 20 is also in direct communication with home automation controller 40, which is in turn directly connected to a device that is not a lighting device, in this example, a garage door opener 50. The home automation controller 40 can be just one of many home automation controllers directly or indirectly connected (via wired or wireless connections) with the home automation controller 20. It is appreciated that each of the home automation controllers 20 and 40 can independently control the lighting device 30 and the garage door opener, although the garage door opener 50 is not controller by the receiving device 10, as indicated by the dashed lines 28 and 32.

As shown in FIG. 1, in one approach, the receiving device includes a decoder 13 and a processing module 14. The decoder 13 is preferably a hardware component programmed to parse a video file incoming from the video source 12 to separate at least one track including at least one ambient light effect associated with at least one portion of the video file.

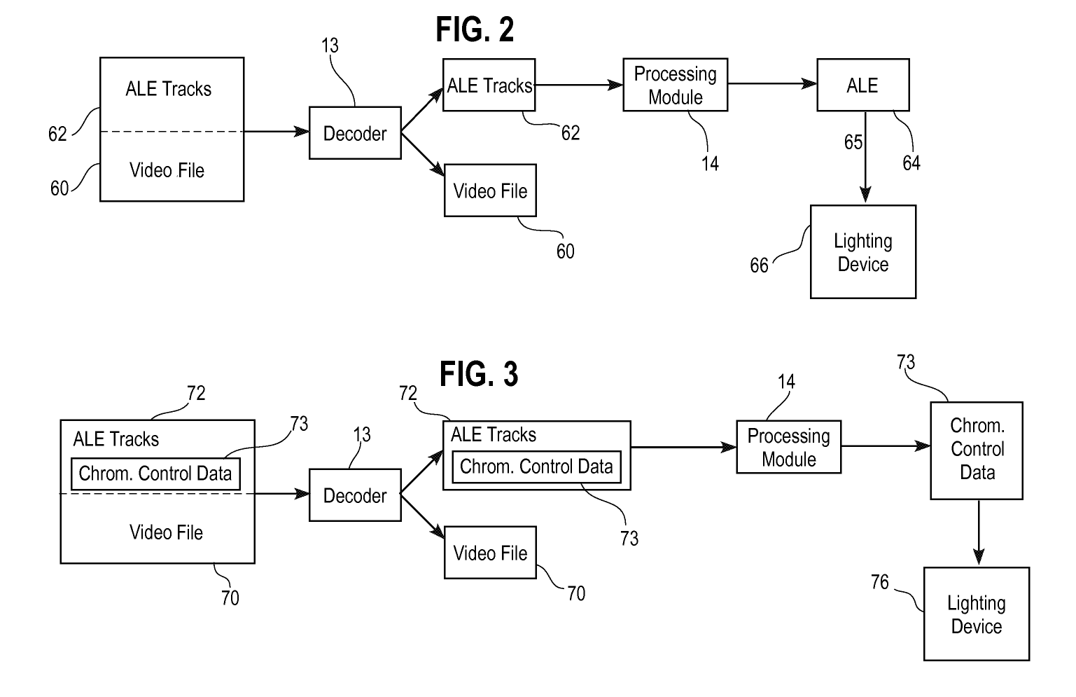

FIG. 2 shows an exemplary digital video stream incoming from the video source 12 and being received by the receiving device 10. The digital video stream 60 includes a digital video file 60 and in one approach illustrated in FIG. 2, at least one portion of the video file 60 contains one or more additional tracks, which are, in one approach, ambient light effect or ALE tracks 62 including data specifying at least one ambient light effect associated with one or more portions or scenes of the program, movie, or game contained in the digital video file 60.

As shown in FIGS. 1 and 2, the decoder 13 of the receiving device, when an incoming video file is received from the video source 12, parses the incoming video file 60 to separate the at least one ALE track 62 from the video file 60. The one or more ALE tracks 62 so separated from the video file 60 include at least one ambient light effect associated with various predetermined portions of the video file 60.

Referring to FIG. 2, the processing module 14 of the receiving device 10 receives the ALE tracks 62 separated by the decoder 13 and detects the ambient light effects 64 associated with one or more portions of the video file 60. In one aspect, the processing module 14 is programmed to detect the at least one ambient light effect included in the at least one track and to generate a command 65 to at least one of the lighting devices 66 in communication with the receiving device 10 to generate the at least one ambient light effect detected in the at least one ALE track 62. The command sent by the processing module 14 can specify that the at least one lighting device 66 generate the at least one ambient light effect detected in the at least one track 62 when the at least one portion of the video file 60 associated with the at least one ambient light effect is displayed to a user.

In one approach shown in FIG. 3, the ALE tracks 72 forming a part of the video file 70 include chrominance control data 73 specifying at least one light color (for example, red, blue, green, or combinations thereof) to be generated by one or more of the lighting devices 16, 18, and 30. When the digital video file 70 is received by the receiving device 10 from the video source 12, the decoder 13 performs the parsing of the digital video file 72 as described in reference to FIG. 2 to separate one or more ALE tracks 72 from the video file 70.

The processing module 14 is programmed to detect data representing one or more ambient light effects included in the ALE tracks 72. As shown in FIG. 3, the processing module 14 of the receiving device 10 is also programmed to perform the parsing of the ALE tracks 72 to detect the chrominance control data 73 contained in the ALE tracks 72 as shown in FIG. 3.

The processing module 14 of the receiving device is also programmed to produce and send one or more commands to one or more lighting devices 16, 18, 30, and 66 to generate the one or more ambient light effects specified in one or more ALE tracks 72 and by the chrominance control data 73. In one approach, the chrominance control data 73 specifies at least one color selected from red, green, blue, or combinations thereof It is to be appreciated that the chrominance control data 73 can specify any other suitable color.

In an approach, the ALE tracks 72 can specify intensity of the colors specified by the chrominance control data 73. In another approach, the ALE tracks 72 can specify at least one of the lighting devices 16 for generating one or more light colors specified by the chrominance control data 73. In yet another approach, the ALE tracks 72 include a predetermined time when the one or more light colors specified by the chrominance control data 73 is to be generated by one or more of the lighting devices 16. In another approach, the ALE tracks 72 can also include data specifying at least one lighting device (16, 18, 30 or 66) for generating the at least one ambient light effect specified in the ALE track 72 and the at least one color specified by the chrominance control data 73.

The lighting devices 16 and 18 can include hardware components such as decoders programmed to interpret the chrominance control data 73 received in the commands from the processing module of the receiving device 10. In another approach, the lighting devices 16 and 18 may include at least one software component adapted for interpreting the chrominance control data 73 received in the commands from the processing module from the receiving device 10.

The systems and methods described herein provide an engaging experience to a user when watching television programming, movies, or playing video games. One advantage of the systems and methods described therein is that television programming, movies, and video games can be made more interactive for a user by including ambient light effects can be generated by one or more lighting devices. Another advantage is that the ambient light effects are generated directly by the video rendering devices based on information detected from the video file representing the television program, movie, or video game.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A system for rendering ambient light effects comprising:
a receiving device including at least one decoder programmed to parse an incoming video file to separate at least one track including at least one ambient light effect associated with at least one portion of the video file; and
a processing module programmed to detect the at least one ambient light effect included in the at least one track and to generate a command to at least one lighting device in communication with the receiving device to generate the at least one ambient light effect detected in the at least one track, wherein the processing module is programmed to send the command to the at least one lighting device for generating the at least one ambient light effect detected in the at least one track when the at least one portion of the video file associated with the at least one ambient light effect is displayed to a user.

2. The system of claim 1, wherein the receiving device is selected from one of a television, set-top box, disc player, personal computer, laptop, tablet computer, and mobile phone.

3. The system of claim 1, wherein the at least one track identifies the at least one lighting device for generating the at least one ambient light effect included in the at least one track.

4. The system of claim 1, wherein the at least one track identifies at least one predetermined event in a video contained in the video file, the predetermined event being associated with the at least one ambient light effect.

5. The system of claim 1, wherein the receiving device and the at least one lighting device are adapted to communicate directly via a wired connection.

6. The system of claim 1, wherein the receiving device and the at least one lighting device are adapted to communicate directly via a wireless connection.

7. The system of claim 1, wherein the receiving device and the at least one lighting device are adapted to communicate indirectly via an intermediate device adapted to communicate with both the receiving device and the at last one lighting device.

8. The system of claim 7, wherein the intermediate device is a wireless controller.

9. The system of claim 1, wherein the receiving device and the at least one lighting device are adapted to communicate indirectly via a home automation controller integrated into the receiving device.

10. The system of claim 9, wherein the at least one home automation controller is in communication with at least one electrical device not in communication with the receiving device.

11. The system of claim 1, wherein the receiving device and the at least one lighting device are adapted to communicate indirectly via a home automation controller located separately from the receiving device.

12. The system of claim 11, wherein the at least one home automation controller is in communication with at least one electrical device not in communication with the receiving device.

13. The system of claim 1, wherein the at least one track includes chrominance control data specifying at least one color of the ambient light effect to be generated by the at least one lighting device, the color being selected from red, green, blue, or combinations thereof.

14. The system of claim 13, wherein the at least one lighting device is adapted to interpret the command received from the receiving device to generate the at least one color specified in the chrominance control data in the at least one track.

15. The system of claim 1, wherein the at least one track includes data specifying brightness level of the at least one ambient light effect to be generated by the at least one lighting device.

16. The system of claim 1, wherein the at least one track includes data specifying a predetermined time for generating the at least one ambient light effect by the at least one lighting device after receiving the command.
